(19) United States
(12) Patent Application Publication
(10) Pub. No.: US 2005/0196577 A1
(43) Pub. Date: Sep. 8, 2005

(54) Vapor barrier ventilation system and method

(76) Inventor: Darrell D. Riste, Kuna, ID (US)

Correspondence Address: PEDERSEN & COMPANY, PLLC, P.O. BOX 2666, BOISE, ID, 83701, US

(21) Appl. No.: 11/066,721

(22) Filed: Feb. 24, 2005

Related U.S. Application Data
(60) Provisional application No. 60/546,912, filed on Feb. 24, 2004.

(51) Int. Cl. B32B 1/04; B32B 3/02

(52) U.S. Cl. 428/76

(57) ABSTRACT

The primary causes of moisture accumulation in sub-structures include moisture rising from the ground and inadequate ventilation within the sub-structure. A vapor barrier ventilation system is provided which uses two systems working in conjunction to successfully first circulate and then extract air and moisture from the sub-vapor barrier area. The first system includes a series of connecting perforated pipes that are covered with round aggregate and then covered by the vapor barrier to circulate air and moisture, and thereby minimize mildew and fungi in the sub-vapor barrier area. The second system consists of vent pipes connected to the perforated pipes, which create a vacuum that may be assisted by an exhaust fan to lift and extract the air, moisture and contaminants from the sub-vapor barrier area to the exterior of the structure. This invention generally relates to the construction of a circulation system for the sub-vapor barrier area and optionally above the vapor barrier of existing structural foundations and new structural foundations.

### CROSS REFERENCE TO RELATED APPLICATIONS

This application claims priority from prior, co-pending U.S. Provisional Patent Application No. 60/546,912 filed Feb 2, 2004, and entitled: “Vapor Barrier Circulation System and Method”, the disclosure of which is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

Lack of air circulation within residential, commercial, and industrial structures can be problematic because as moisture accumulates, it promotes growth of toxic and non-toxic molds, fungi, and bacteria. A growing concern has been adequate air circulation of these structures to prevent accumulation of moisture and therefore its harmful side effects.

A substantial source of moisture, toxic mildew, fungi, and bacteria accumulation occurs within the sub-structure area. This has been known to cause serious problems, such as, but not limited to, damage to the foundation walls, footings, wooden joists, trusses, and sub-flooring. In addition, this has been known to cause damage to the interior supports, furnishings, and painted surfaces, among other problems. Said toxins have also been linked to many health disorders, including, but not limited to, respiratory and immune disorders, liver damage, asthma complications, allergic reactions, and general discomfort.

As building materials have changed, as well as building codes and standards, this moisture accumulation problem has increased, as, for example, spacing between structures have decreased, limiting the natural circulation process relied upon to prevent moisture accumulation and the said problems associated with it. This has led to the development of ventilation systems used to counteract the moisture development, primarily within the sub-structure. See, for instance, U.S. Pat. Nos: 5,931,603; 6,629,390; 6,065,901; 5,003,750; and 5,474,400. These disclosed systems, however, tend to be expensive, complicated and/or tend to limit the amount of versatility for the sub-structure, or rely on an additional concrete layer or form-drains.

Existing sub-structure ventilation technologies often deal only with the section above the vapor barrier beneath the sub-structure or crawl space of an enclosed structure. Generally, a layer of impermeable material is used as a vapor barrier within the sub-structure to help prevent the transfer of moisture from the soil into the sub-structure and ultimately, up into the interior structure. This technique is problematic itself, as it allows condensation to build up on the bottom surface of the barrier and frequently also does not successfully prevent moisture or excess water from rising past the barrier and into the sub-structure, or area directly above the vapor barrier. Typically, most existing technologies do not allow for the ventilation of the sub-vapor barrier area and rely specifically on a ventilation system placed above it.

The conventional ventilation system, usually comprising foundation vents and/or the use of one or more fans, is used to help circulate the air inside the sub-structure to prevent accumulation of moisture and pollutants that may cause said damage. These technologies suffer in reducing the moisture accumulation. Most existing vents must be placed in a specific pattern to ensure ventilation, or utilize specific wind-draft patterns, that often are not practical with existing structural designs; or the vapor barrier, preventing moisture from rising up from the ground level, is insufficient. In addition, most fan systems do little to eradicate the problem of moisture accumulation, as they still rely on the vapor barrier to prevent the moisture from rising up, and require a significant amount of vacuum power to adequately circulate the air.

The present invention solves the problems of existing ventilation technologies by withdrawing the air from within the sub-vapor barrier area to reduce or prevent moisture accumulation therein. This sophisticated and low-cost system creates air circulation for a drier environment, aiding in the prevention of costly damage to the enclosed structure and its foundation. By creating air circulation, the system creates an avenue to extract moisture that may otherwise result in mildew and fungi problems within the substructure as well as interior structure. In addition, the substructure remains free of complicated or bulky machinery and can still be utilized. The present invention can be used for existing structural foundations as well as new structural foundations.

### BRIEF SUMMARY OF THE INVENTION

One aspect of the present invention is to circulate air and extract moisture from the sub-vapor barrier to a location external of the structure in a building foundation. This is accomplished by two systems working in conjunction with one another to circulate air and moisture in the sub-vapor barrier region of a sub-structure and then to extract it from the structure by means of one or more external vents.

The first system, the sub-vapor barrier circulation system, uses a series of connecting relatively thin, perforated or semi-permeable pipe sections that are laid on the ground underneath the structure adjacent to the foundation walls and footings, as well as run laterally across the open sections of the sub-structure, to form an integral flow path or conduit for air and moisture. These connected pipe sections are then preferably surrounded and covered with a relatively thin permeable layer of loosely placed round rock that creates a conduit effect that allows air circulation and usually creates a drier environment. This aggregate layer or conduit is then covered with the vapor barrier. As air is circulated in the aggregate layer surrounding the pipe, the vacuum created by the pipe and the extraction system draws the circulating air and moisture through the small perforations in the pipe and into the pipe to begin extract it from the sub-vapor barrier space.

The second system, the air extraction system, consists of one or more vent pipes extending preferably from the foundation wall side of the perforated pipe and up into the substructure. The vent pipe is connected in series with one or more motorized fans, a motor, a power source, and finally the one or more external vents. The motorized fan is preferably powered by an electrical power source. A timer may be used to set the time duration that the motorized fan is powered during and the timer may be programmed to respond to a variety of factors. Air and moisture is extracted through the perforated pipes by the vacuum created by the vent pipes and the fan, and is impelled upwards, through the fan, and expelled out through the external vent.

Another aspect of the invention is the circulation of air in the sub-vapor barrier to a location external of the structure in an existing foundation. Although the aggregate layer is an asset, transportation and placement of the aggregate layer under an existing structure could be costly and laborious. Therefore the present invention could be modified by replacing the aggregate layer and utilizing additional perforated lateral pipe sections.

It is therefore an object of the invention to provide a simple and low cost method of circulating the air in the sub-vapor barrier to create a drier environment.

It is an object of the invention to provide an air circulation system for use in sub-structures that will extract air from the sub-vapor barrier area as well as above the vapor barrier.

It is an object of the invention to provide an air circulation system that will create a dry environment that creates unfavorable conditions for mildew, fungi, and bacteria growth within a sub-structure and above it.

It is an object of the invention to provide an efficient means of reducing and/or preventing moisture accumulation and pollutants from reaching the interior structure.

It is an object of the invention to provide an avenue to circulate air in the sub-vapor barrier area.

Other aspects of the invention will be more readily apparent upon reading the following description of embodiments of the invention and upon reference to the accompanying drawings wherein:

### BRIEF DESCRIPTION OF THE DRAWINGS

FIG. 1 is an plan view of one embodiment of the vapor barrier circulation system of the present invention within a foundation sub-structure.

FIG. 2 is a partial, cross sectional, perspective view of one embodiment of a perforated pipe of the sub-vapor barrier circulation system of the present invention.

FIG. 3 is a cross sectional view of the fastener used to hold pipe in a secure location in the sub-vapor barrier system of the present invention.

FIG. 4 is a partial cross sectional elevation view of the extraction system of the present invention extracting circulating air from the sub-vapor barrier area through an external vent.

FIG. 5A is a partial, cross sectional view of the vent casing of the present invention inserted into the foundation.

FIG. 5B is a partial, perspective cross sectional view of the external vent of the present invention communicating with a location external of the structure.

FIG. 6 is a plan view of the vapor barrier circulation system of the present invention that is used when the aggregate layer is not utilized.

FIG. 7 is a partial, cross sectional elevation view of a vapor barrier circulation system of the present invention that is also used to ventilate the area directly above the vapor barrier.

### DETAILED DESCRIPTION OF A PREFERRED EMBODIMENT OF THE INVENTION

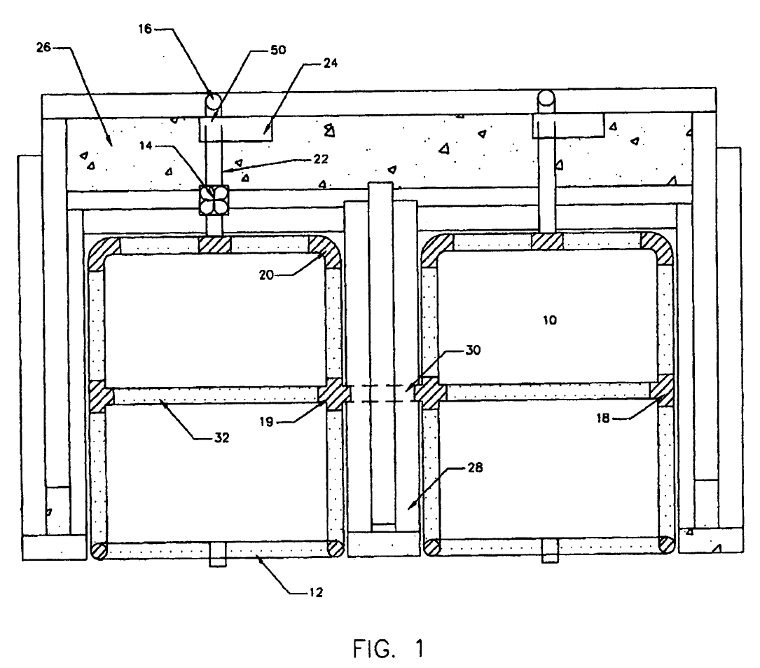

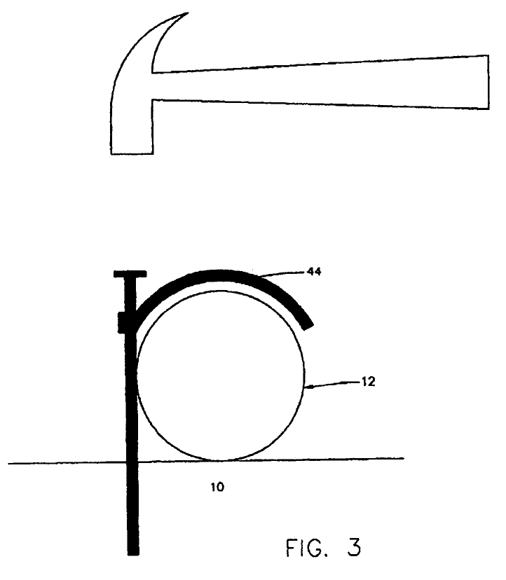

A plan view of one embodiment of a vapor barrier circulation system according to the invention is shown in FIG. 1. As can be seen from the drawing, foundation walls 26 surround the area underneath the residential, commercial, or industrial structure and comprise a boundary for the purposes of this explanation. Adjacent to the foundation walls 26 are the perforated pipe sections 12, which are snapped or screwed together to encompass the sub-vapor barrier area 10 by 90-degree couplers 20 in the corners and Tee couplers 18 wherever a lateral section of perforated pipe 32 is required. Lateral pipes 32 are preferred to cross and join perforated pipe sections 12 at every 6 to 10 feet of interior space. Generally one or more footings 28 are placed within and extending to the foundation walls 26 for additional support of the structure. Adjacent to these footings 28 are additional sections of perforated pipe 12. At the base of the footings 28, holes may be drilled and sleeves 30 can be placed through the hole to connect all sections of pipe 12 with either Tee couplers 18 or cross couplers 19 so that sufficient coverage of the foundation area is achieved. Referring briefly to FIG. 3, the perforated pipe sections 12 are fastened to the soil of the foundation area by long fasteners 44, which hold the pipe secure and prevent accidental movement during the placement of an optional aggregate layer 40 or after.

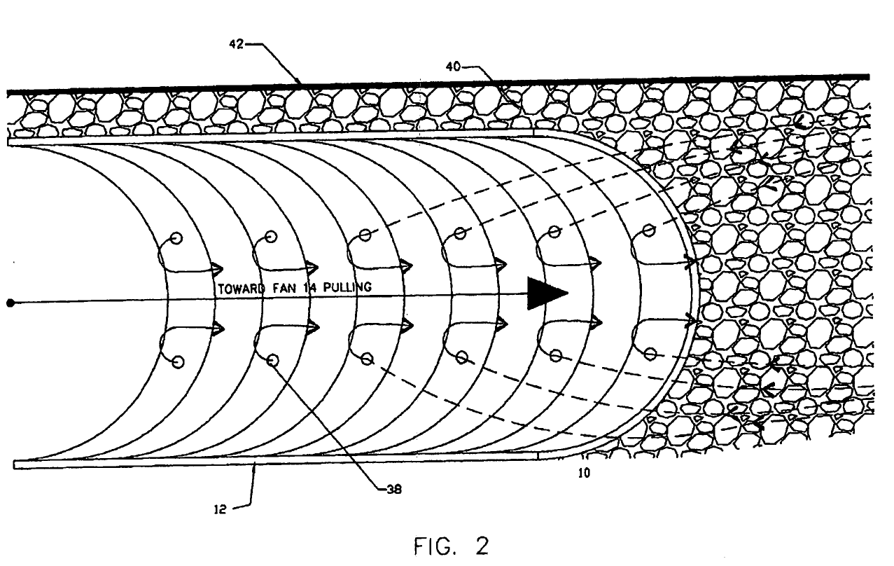

Referring now to FIG. 2, a partial cross section of the perforated pipe 12 and sub-vapor barrier area 10 surrounding it is disclosed. Perforated pipe 12 is generally a hollow pipe with a relatively thin wall that is either semi-permeable or contains many perforations 38 extending its surface. One such type of perforated pipe 12 is known as ADS, or “Advanced Drainage System” pipe and is a commercially available product with six rows of perforations 38 extending longitudinally on its surface. The perforated pipe 12 is preferably about 1 to 6 inches in diameter, however, the size may be varied according to the particular needs of the sub-vapor barrier area to be ventilated. In addition, the size and placement of the perforations 38 along its surface may be varied to accommodate many different needs. Each pipe section 12 is connected together using standard couplers 20 or 18 which are a commercially available product and are not required to contain the perforations 38 as disclosed in the pipe sections 12. In addition, one or more Tee couplers 18 are laid horizontally and a 90-degree coupler 20 is used to extend vertically from the pipe sections 12 in order to connect perforated pipe sections 12 to the vent pipe 22. The vacuum created in the connecting pipe sections 12 by motorized fan as well as natural airflow caused by the resultant negative air pressure in the sub-vapor barrier area allows air and moisture to be drawn into the pipe sections 12 and travel along them into the vent pipe 22, which will be discussed in future detail.

Optional aggregate layer 40 is preferably ¾ to 2 inch round rock or any other layer of semi-permeable rock or gravel which will suit the purposes of providing a conduit for air and moisture. Aggregate layer 40 is transported into the foundation area by suitable and well-known means in the art and spread to sufficiently cover all soil areas within the foundation as well as the perforated pipe 12. Aggregate layer 40 preferably extends the length and width of the sub-structure, from the foundation walls 26 to the base of the footings 28. Preferably the layer 40 is 2 to 8 inches thick, however, the thickness may be varied according to the amount of air circulation required. During the spreading of the aggregate layer 40, pipe fasteners 44 act to secure the perforated pipe sections 12 and prevent movement of them, shown in FIG. 3. At each 90-degree coupler 20 extending vertically for connection to the one or more rigid vent 22, care should be taken not to cover the coupler 20 with aggregate when spreading. Once the aggregate layer 40 is evenly spread, the vapor barrier 42 is laid. Vapor barrier 42 preferably consists of multiple sheets of polyethylene plastic, generally 6 millimeters thick, which are overlapped to help prevent air and moisture from escaping the aggregate layer 40. Other means of creating a vapor barrier 42 may be used, including varying the thickness of material or changing the type of barrier used, so long as it is moderately impermeable according to standard building codes and practices. The vapor barrier 42 is laid to the base of the foundation walls 26 and may overlap onto the footings 28. In an alternate embodiment, the vapor barrier may be sealed along it edges by caulking or another means.

At the base of footing 28, a hole or bore can be drilled through the footing 28 and inserted with a sleeve 30, preferably of a rigid plastic material and the same size as perforated pipe 12. Tee couplers 18 may then be used to connect the sleeve with perforated pipe sections 12, thereby completing a full conduit of laid pipe on the base of the sub-structure.

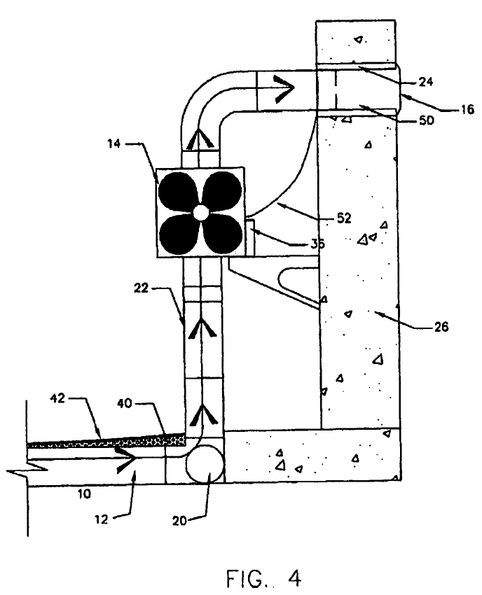

Referring to FIG. 4, a depiction of the connection between the pipe system and the extraction system is disclosed. A cylindrical hole, preferably the size of 90-degree coupler 20, is cut into the vapor barrier 42 to allow connection to the vent pipe 22 at each location of vent pipe 22. The one or more 90-degree couplers 20 are used to connect a section of perforated pipe 12 to the vent pipe 22 preferably adjacent to a foundation wall 26 that contains foundation vents 24.

Vent pipe 22 is preferably made of a solid, hardened plastic or metal material and is sealed to prevent leakage. Vent pipe 22 extends vertically from the base of the sub-structure in a location generally adjacent to a foundation vent 24 to facilitate the extraction of air and moisture from area 10. Along the vertical path of pipe 22, an inline motorized fan 14 may be connected in a sealed relationship to the pipe 22, by rubber couplers with clamps or threaded couplers, or any other means; and is preferably mounted to the foundation wall 26 with a bracket or other means of securely fastening it to prevent movement or instability. Motorized fan 14 is generally known in the art as an inline fan and is able to provide the draft force necessary to extract air from the perforated pipe sections 12, which is dependent upon the volume of the pipe network and the number of fans used. Motorized fan 14 is connected to a power source 52 and preferably also timer 36. Timer 36 is also generally known in the art, and may be programmed to be activated for certain time intervals or by a rheostat, dependent upon season or temperature levels, or may be activated by sensors underneath the vapor barrier 42 for detecting threshold levels of humidity, or any combination thereof. The power source 52 preferably carries electrical power to the fan for operation thereof.

Moisture is then extracted through the fan 14, up further vertical sections of vent pipe 22, and then out through vent casing 50 to be expelled from external vent 16.

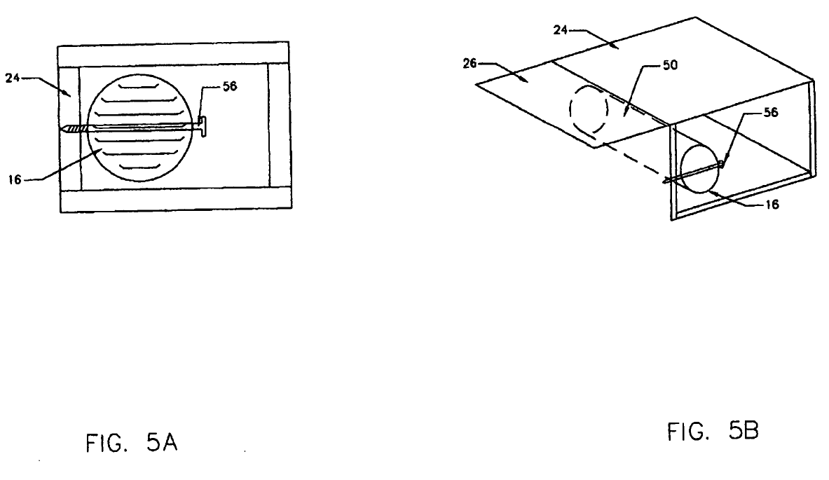

As can be seen from FIGS. 5A and 5B vent pipe 22 extends to foundation vent 24, preferably on the east side of house or the opposite side from prevailing wind, and a vent casing 50 is placed within foundation vent 24 at each occurrence of vent 16. A vent casing 50 is then connected to vent pipe 22 of the interior of foundation vent 24. Connection between vent pipe 22 and vent casing 50 is preferably a tight seal that prevents air from escaping. Vent casing 50 may be constructed of any hardened plastic or metal material that resists ordinary wear from exposure to the exterior of foundation wall 26. The surrounding area of foundation vent 24 is then sealed with 2-inch foundation foam to prevent air from above the vapor barrier to escape out of it and reduce the need for opening or closing the vent 24 based on seasonal need. External vent 16 is then rigidly attached to the surface of vent casing 50 by snapping into a grooved interior surface of casing 50. External vent 16 is preferably insect and vermin proof and may contain screens or filters. Fastener 56, preferably a long screw able to be threaded into concrete, is used to fasten external vent 16 to the sidewall of foundation vent 24 to secure the vent 16 in place and guard against accidental dislodging from foundation vent 24. In additional, external vent 16 may contain means for testing the extracted air for content or quantity levels, which would be conveniently located for monitoring. Air and moisture passed through vent casing 50 and external vent 16 after being propelled upwards by motorized fan 14, to be expelled to the exterior of the structure.

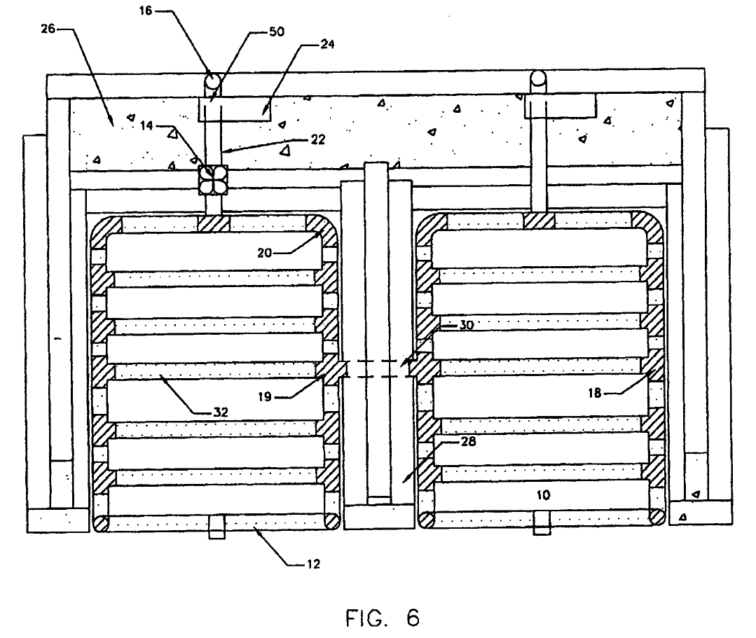

In the instance that the vapor barrier circulation system is to be placed into an existing foundation, and problems may arise out of the transport and laying of the aggregate layer 40, or for a more cost effective system, the aggregate layer 40 may be eliminated and replaced by using more lateral extensions 32, shown in FIG. 6. If necessary, many forms of support may be used the preserve the versatility of the sub-structure.

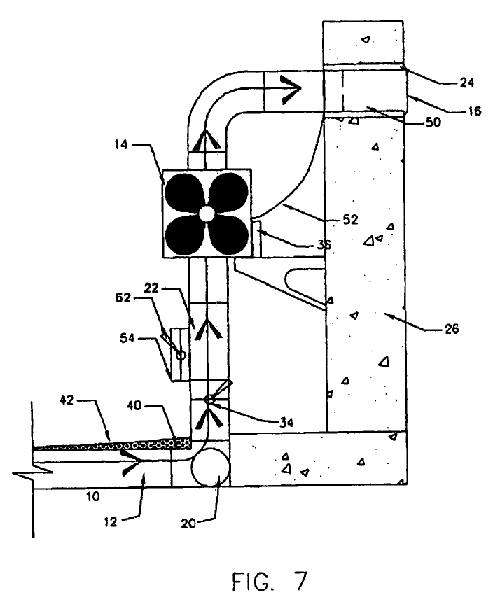

An alternate embodiment of FIG. 4 is shown in FIG. 7. A vapor barrier circulation system including also ventilation of area above the vapor barrier 42, is disclosed. A valve 32 may be placed below the motorized fan 14 within rigid pipe 22. This valve may be operated by mechanical, electrical, or pneumatic means to shut off flow from sub-vapor barrier area 10. A sub-structure inlet 54 preferably contains a valve 62, which may be operated by mechanical, electrical, or pneumatic means to shut off flow from above the barrier 42. This valve 62 may be utilized in conjunction with valve 32 to prevent flow from area 10 and enable the flow of moisture from the area above barrier 42 into the vent pipe 22, to be exhausted out of external vent 16 when desired or programmed by timer 36 or another means.

The vapor barrier circulation system may be used in conjunction with water drainage means in additional embodiments. Also, the vapor barrier circulation system may be laid on a grade to assist in water drainage means.

In further embodiments, the vapor barrier circulation system described may be used in conjunction with other systems to heat and/or cool the area above the vapor barrier. Also, the perforated pipes 12 may be laid in many different patterns, including a snake-like pattern, to achieve ventilation of air from the sub-vapor barrier. The distal ends of the pipes 12 (farthest from vent pipe 22) may be open, to created a flow-through type system. Or the distal pipe ends may be capped, or closed, to maximize flow within the sub-vapor barrier area.

It will be thus seen that the objects set forth above, and those made apparent from the preceding description, are efficiently attained. It will also be apparent to those skilled in the art that changes may be made in the construction without departing from the spirit of the present invention. It is intended, therefore, that the description and drawings be interpreted as illustrative and that the following claims are to be interpreted in keeping with the spirit of the invention, rather than limited to the specific details set forth.

Although this invention has been described above with reference to particular means, materials, and embodiments, it is to be understood that the invention is not limited to these disclosed particulars, but extends instead to all equivalents within the scope of the following claims.

1. A sub-building-structure ventilation system comprising:
a length of perforated or semi-permeable pipe laid on the ground underneath a building structure to create a flow path for air and moisture;
an impermeable vapor barrier above said perforated or semi-permeable pipe;
a motorized fan located in said flow path; and
a vent pipe extending said flow path out from under said building structure.

2. The ventilation system of claim 1, wherein the perforated or semi-permeable pipe is surrounded and covered by a layer of loose rock.

3. The ventilation system of claim 1, wherein said vent pipe extends through said impermeable vapor barrier.

4. The ventilation system of claim 1, wherein said vent pipe extends through a foundation wall of said building structure.

5. The ventilation system of claim 1, wherein the distal end of said perforated or semi-permeable pipe is open.

6. The ventilation system of claim 1, wherein the distal end of said perforated or semi-permeable pipe is closed.

7. The ventilation system of claim 1, which also comprises a valve to enable venting from space underneath said building structure which is above said impermeable vapor barrier.
